(19) United States
(12) Patent Application Publication
(10) Pub. No.: US 2017/0359177 A1
(43) Pub. Date: Dec. 14, 2017

(54) Method and System for Cryptographic Decision-making of Set Membership

(71) Applicant: UNIVERSITY OF SCIENCE AND TECHNOLOGY BEIJING, Beijing (CN)

(72) Inventors: Yan ZHU, Beijing (CN); Ruyun YU, Beijing (CN); Ruiqi GUO, Beijing (CN); Xin WANG, Beijing (CN)

(21) Appl. No.: 15/542,211

(22) PCT Filed: Feb. 13, 2015
(86) PCT No.: PCT/CN2015/072982

§ 371 Date: Jul. 7, 2017

(30) Foreign Application Priority Data
Jan. 12, 2015 (CN) 201510013367.1

(51) Int. Cl. H04L 9/30; H04L 9/06

(52) U.S. Cl. CPC H04L 9/3026; H04L 9/0643

(57) ABSTRACT

A cryptographic decision-making of set membership is a method or system which make a secure decision-making for positive membership e∈S or negative membership e∉S in an unforgeable and non-repudiation way for any element e and a set S. The proposed method of the present invention comprises: acquire a set U={e₁, . . . , eₙ} and map each element eᵢ in U into a random point vᵢ in a cryptography space; acquire a set S={e′₁, . . . , e′ₘ}⊂U, determine a random point v′ᵢ corresponding to each element e′ᵢ in the set S, and construct a function ƒ_{S}(x) according to all random points v′ᵢ; introduce a random secret γ to generate ƒ_{S}(γ) by using the function ƒ_{S}(x), and produce a public parameter mpk according to the random secret γ; and generate the cryptographic representation of set S by using the function ƒ_{S}(γ) and the public parameter mpk. In the embodiments, we provide two kinds of cryptographic representations of set, including Poles-based Aggregation and Zeros-based Aggregation, to make the decision on positive membership eᵢ∈S and negative membership eᵢ∉S.

### FIELD OF THE INVENTION

The presently claimed invention relates generally to information technology. The invention also relates to cryptographic methods for secure decision-making of set-membership used in secure group communication.

### BACKGROUND OF THE INVENTION

The ‘positive’ membership and ‘negative’ membership are two of most common binary relations. For a given set U={e₁, . . . , eₙ} and any a subset S⊂U, the positive membership is usually expressed as ∈, e.g., e∈S denotes the element e is in the set S. Similarly, the negative membership is as ∉, e.g., e∉S denotes e is not in S. When there exists only one element in the set, the ‘positive’ membership and ‘negative’ membership are converted into the ‘equal’ and ‘unequal’ relationship, respectively. These two basic memberships also induce several complex relationships, including ‘inclusion’, ‘exclusion’, ‘set-equal’, ‘set-unequal’, etc. Especially, the ‘negative’ membership is also regarded as NOT-logic or Complement-logic that is used widely in decision analysis and logic judgment.

In cryptography, ‘positive’ and ‘negative’ membership are always used to make a secure decision on set membership, that is, the ‘positive’ and ‘negative’ membership denote whether a given element e exists (or does not exist) in a set S. This kind of decisions is required to be cryptographically secure, for example, if e∈S (or e∉S), no one can declare wrong relationship e∉S (or e∈S) to the others.

Cryptographic set operations over ‘positive’ and ‘negative’ membership and NOT-logic have an important value in theory and application for designing security protocols and secure computation algorithms, such as broadcast encryption (BE), attribute-based encryption (ABE), predicate encryption (PE), function encryption (FE), and privacy-protection keyword query (PPKQ), etc. The cryptographic ‘positive’ and ‘negative’ membership is in essence a secure computation technology, which is a basic mechanism to protect information assets under open network environment. This kind of technology has been widely used in the E-commerce, E-government, online trading, and even military networks.

Let us see an example in group-oriented broadcast encryption. We assume that a broadcaster wants to send an encrypted sensitive message to all users, but only specified users can use their private keys to decrypt received messages. It will be easy to implement with help of cryptographic ‘positive’ and ‘negative’ membership: Let S be a set of these specified users. The broadcaster encapsulates S into the encrypted message, and e is tied to user's private key. If e∈S, the user can decrypt the received message; otherwise, the user, even if he has the previous license, is unable to decrypt the received message.

Let us see another example in attribute-based encryption (ABE). An attribute set is composed of different values, e.g., City={‘Beijing’, ‘Shanghai’, ‘Shenzheng’, ‘London’, ‘New York’ . . . }. The message sender can choose some values from this set to form an ‘authorized’ or ‘non-authorized’ subset, which will decide what values will be authorized or unauthorized to decrypt the message. In addition, each member in cryptosystem is assigned some attribute values and the corresponding attribute-keys to identify his identity. With help of cryptographic decision-making method of set-membership in this invention, the receiver compares the values hidden by the attribute-keys with the encrypted subset in the ciphertext when he tries to recover the message. If the comparison result satisfies the ‘positive’ (or ‘negative’) membership over the subset, he can decrypt the message correctly. However, there does not exist this kind of cryptographic decision-making method of set-membership in the literature at present. Our method will fill the vacancy of this field in cryptography.

### SUMMARY OF THE INVENTION

It is, accordingly, an object of this invention to provide a construction, method, and system for cryptographic decision-making of set membership, in order to solve the problem that there does not exist an effective method to implement cryptographic representation of set membership in the existing literature.

The present invention provides a cryptographic construction method for determining a set membership, comprising:
acquiring any given set U={e₁, . . . , eₙ}, and transforming each element eᵢ in the set U into a random point vᵢ in a cryptographic space;
acquiring a given set S={e′₁, . . . , e′ₘ}⊂U, determining a random point v′ᵢ corresponding to each element e′ᵢ in the set S according to the random point vᵢ, and constructing a function ƒ_{S}(x) according to the random point v′ᵢ;
introducing a random secret γ, determining a function ƒ_{S}(γ) according to the function ƒ_{S}(x), and determining a public parameter mpk according to the random secret γ; and
processing the function ƒ_{S}(γ) by using the public parameter mpk as an input to generate a cryptographic representation of the set S via a cryptographic method.

Further, the random point comprises a random number or a random vector; constructing a function ƒ_{S}(x) according to the random point v′ᵢ comprises:
constructing a zeros-based polynomial ƒ_{S}(x) by setting the random point v′ᵢ corresponding to each element e′ᵢ in the set S as a zero of the polynomial H(x); or
constructing a poles-based polynomial ƒ_{S}(x) by setting the random point v′ᵢ corresponding to each element e′ᵢ in the set S as a pole of the polynomial H(x);
wherein H(x) is a rational polynomial with a form H(x)=P(x)/Q(x), which is the quotient of two polynomial P(x) and Q(x); for a variable z, the root z of P(x) is called a zero of H(x) if P(z)=0, and the root z of Q(x) is called a pole of H(x) if Q(z)=0;
the constructed function also comprises a Lagrange interpolation polynomial, Newton interpolation polynomials, Hermite interpolation polynomials, Bernstein polynomials and Fibonacci polynomials, Binomial polynomials or corresponding algebraic curves constructed from the random point v′ᵢ.

Further, the processing the function ƒ_{S}(γ) by using the public parameter mpk as an input to generate a cryptographic representation of the set S via a cryptographic method comprises:
processing the function ƒ_{S}(γ) by using the public parameter mpk as an input to generate an aggregation function Aggregate(mpk,S) of the set S via cryptographic method, wherein the aggregation function is called a zeros-based aggregation function ZerosAggr(mpk,S) if the function ƒ_{S}(x) is a zeros-based polynomial, or the aggregation function is called a poles-based aggregation function PolesAggr(mpk,S) if the function ƒ_{S}(x) is a poles-based polynomial; and
compressing the set S into a constant-size random number or random vector R_{S} by means of the aggregation function, wherein R_{S} is an aggregated value outputted by the aggregation function Aggregate(mpk,S), and the size of R_{S} is independent of the number of elements in the set S.

Further, after the compressing the set S into a constant-size random number R_{S} by means of the aggregation function, further comprising:
constructing a cryptographic determination algorithm by means of the aggregation function for determining equality and inequality relationships between elements; and/or constructing a cryptographic determination method by means of the aggregation function for determining positive and negative affiliation memberships between elements and the set; and/or
constructing a cryptographic determination method by means of the aggregation function for determining positive and negative containment relationships between the sets.

Further, the constructing a cryptographic determination algorithm by means of the aggregation function for determining a positive affiliation membership between elements and the set comprises:
acquiring an element eᵢ, and when eᵢ∈S, setting S₋=S\{eᵢ}, then determining the aggregated value R_{S}_{_{−}} by the zeros-based aggregation function ZerosAggr(mpk,S₋); and
when eᵢ∉S, setting S₋=s\{eᵢ}, then determining the aggregated value R_{S}_{_{−}} by none of polynomial-time algorithms, the polynomial-time algorithms comprise ZerosAggr(mpk,S₋);
the constructing a cryptographic determination algorithm by means of the aggregation function for determining a negative affiliation membership between elements and the set comprises:
acquiring an element eᵢ, when eᵢ∉S, setting S₊=S∪{eᵢ}, then determining the aggregated value R_{S}_{₊} by the pole-based aggregation function PoiesAggr(mpk,S₊); and
when eᵢ∈S, setting S₊=S∪{eᵢ}, then determining the aggregated value R_{S}_{₊} by none of polynomial-time algorithms, the polynomial-time algorithms comprise PolesAggr(mpk,S₊).

Further, the constructing a cryptographic determination algorithm by means of the aggregation function for determining a positive affiliation membership between elements and the set comprises:
constructing a commitment on the aggregated value R_{S} according to the outputted aggregated value R_{S} of the set S from the poles-based aggregation function PolesAggr(mpk,S);
for the element eᵢ, when eᵢ∉S, verifying the commitment according to the determined aggregated value R_{S}_{_{−}} outputted by the zeros-based aggregation function ZerosAggr(mpk,S₋); and
when eᵢ∈S, verifying the commitment by none of polynomial-time algorithms;
the constructing a cryptographic determination algorithm by means of the aggregation function for determining a negative affiliation membership between elements and the set comprises:
constructing a commitment on the aggregated value R_{S} according to the outputted aggregated value R_{S} of the set S from the zeros-based aggregation function ZerosAggr(mpk,S);
for the element eᵢ, when eᵢ∈S, verifying the commitment according to the determined aggregated value R_{S}_{_{−}} outputted by the poles-based aggregation function PolesAggr(mpk,S₊); and
when eᵢ∈S, verifying the commitment by none of polynomial-time algorithms.

A cryptographic construction system for determining a set membership, comprising:
a randomizing unit, which is configured to acquire any given set U={e₁, . . . , eₙ} and transform each element eᵢ in the set U into a random point vᵢ in a cryptographic space;
a function generating unit, which is configured to acquire a given set S={e′₁, . . . , e′ₘ}⊂U, determine a random point v′ᵢ corresponding to each element e′ᵢ in the set S according to the random point vᵢ, and construct a function ƒ_{S}(x) according to the random point v′ᵢ;
a secret point determining unit, which is configured to introduce a random secret γ, determine a function ƒ_{S}(γ) according to the function ƒ_{S}(x), and determine a public parameter mpk according to the random secret γ; and
a cryptographic processing unit, which is configured to process the function ƒ_{S}(γ) by using the public parameter mpk as an input to generate a cryptographic representation of the set S via a cryptographic method.

Further, the cryptographic processing unit comprises:
a processing module, which is configured to process the function ƒ_{S}(γ) by using the public parameter mpk as an input to generate an aggregation function Aggregate(mpk,S) of the set S via cryptographic method, wherein the aggregation function is called a zeros-based aggregation function ZerosAggr(mpk,S) if the function ƒ_{S}(x) is a zeros-based polynomial, or the aggregation function is called a poles-based aggregation function PolesAggr(mpk,S) if the function ƒ_{S}(x) is a poles-based polynomial; and
a compressing module, which is configured to compress the set S into a constant-size random number or random vector R_{S} by means of the aggregation function, wherein R_{S} is an aggregated value outputted by the aggregation function Aggregate(mpk,S), and the size of R_{S} is independent of the number of elements in the set S.

Further, the cryptographic construction system further comprising:
a first determination unit, which is configured to construct a cryptographic determination algorithm by means of the aggregation function for determining equality and inequality relationships between elements; and/or
a second determination unit, which is configured to construct a cryptographic determination algorithm by means of the aggregation function for determining positive and negative affiliation memberships between elements and the set; and/or
a third determination unit, which is configured to construct a cryptographic determination algorithm by means of the aggregation function for determining positive and negative containment relationships between the sets.

Further, the second determination unit is further configured to acquire an element eᵢ, and when eᵢ∈S, set S₋=S\{eᵢ}, then determine the aggregated value R_{S}_{_{−}} by the zeros-based aggregation function ZerosAggr(mpk,S₋); and when eᵢ∉S, set S₋=S\{eᵢ}, then determine the aggregated value R_{S}_{_{−}} by none of polynomial-time algorithms, the polynomial-time algorithms comprise ZerosAggr(mpk,S₋); and
the second determination unit is further configured to acquire an element eᵢ, when eᵢ∉S, set S₊=S∪{eᵢ}, then determine the aggregated value R_{S}_{₊} by the pole-based aggregation function PoiesAggr(mpk,S₊); and when eᵢ∈S, set S₊=S∪{eᵢ}, then determine the aggregated value R_{S}_{₊} by none of polynomial-time algorithms, the polynomial-time algorithms comprise PoiesAggr(mpk,S₊).
According to the fourth aspect of the presented invention, there are provided some advantageous features comprising:

The Aggregation algorithm supports the aggregation of any number of elements in a given set, that is, there is no restrict on the number of aggregated elements, such that our system will provide the cryptographic decision-making for membership over a set of any size.

The presented system supports cryptographic decision-making for ‘positive’ and ‘negative’ membership, simultaneously. The reason is that these two kinds of decision-making methods only need two aggregation functions: PolesAggr(•) and ZerosAggr(•).

The presented decision-making method for ‘positive’ and ‘negative’ membership is secure with unforgeability and non-repudiation based on the difficulty in computing the aggregated values for two error settings, eᵢ∉S but S₋=S\{eᵢ}, and eᵢ∈S but S₊=S∪{eᵢ}. The reason is that the zeros-based (or poles-based) aggregation values R_{S}_{_{−}} (or R_{S}_{₊}) cannot be computed by any polynomial-time algorithm (regarded as any attacker), including the aggregation function ZerosAggr(mpk,S₋) (or PolesAggr(mpk,S₊)).

The presented cryptographic decision-making method may provide a foundation for the cryptography research on set theory. Considering that modern mathematic is foundation on set theory, the solution to the decision-making problem of basic membership inevitably lead to solving a series of related cryptographic problems, especially in secure (unilateral, two-party, multiparty) computing, including Privacy-based Data Retrieval, Keyword Search of Confidential Database, Group Encryption, Predicate Encryption, Attribute-based Encryption, Cryptography-based Access Control and so on.

### BRIEF DESCRIPTION OF THE DRAWINGS

FIG. 1 is a system diagram illustrating cryptographic decision-making of positive membership in accordance with the embodiment of the invention;

FIG. 2 is a system diagram illustrating cryptographic decision-making of negative membership in accordance with the embodiment of the invention;

FIG. 3 is a structural diagram of cryptosystem illustrating decision-making of membership in accordance with the embodiments of the invention.

### DETAILED DESCRIPTION OF EXEMPLARY EMBODIMENTS

In order that the invention may be more clearly understood, embodiments thereof will now be described, by way of example only, with reference to the accompanying drawings, in detail.

The presented invention aims at the issue that the set-membership cannot be expressed and decided in cryptography in the literature at present, and provide the cryptographic methods of secure decision-making of set-memberships.

An embodiment of the invention is described as follows:

(1) Aggregation Function

In this embodiment, the core notion is aggregation function based on cryptographic representation of subsets. Given a set U, an aggregation function is a cryptographic function to compress the information of any subset S⊂U into a constant-size value. The output of aggregation function is called the cryptographic representation of subset. This function is stated as follows:

Let PK denote the public key space over a group G and U={e₁,L,eₙ}, the function Aggregate: PK×2^{U}→G is a deterministic polynomial-time algorithm satisfying:

Aggregate(mpk,S)=R_{S}, (1)

where mpk is the public key in PK, S⊂U, and R_{S} is an element in G.

Note that, the aggregation function is an open function because it merely takes as input the public key and does not require any secret information for its operation.

The aggregation function serves as the foundation for making cryptographic decisions on set memberships, i.e., positive membership e∈S and negative membership e∉S. More exactly, we construct two aggregation functions, ZerosAggr and PolesAggr, for decision-making on positive membership (e∈S) and negative membership (e∉S), respectively.

Before we present the two aggregation functions, we first give the definition of zeros and poles in a rational polynomial function as follows:

H(x) is a rational polynomial with a form H(x)=P(x)/Q(x), which is the quotient of two polynomial P(x) and Q(x); for a variable z, the root z of P(x) is called a zero of H(x) if P(z)=0, and the root z of Q(x) is called a pole of H(x) if Q(z)=0;

Based on this definition, there is provided a construction method for two aggregation functions, Zeros-based aggregation ZerosAggr and Poles-based aggregation PolesAggr.

(2) Construction of Zeros-Based Aggregation Function

Firstly, the function ZerosAggr is constructed according to four following phases:

1) Randomizing Phase

Let G be a multiplicative cyclic group of prime order p and g is a generator of G. Given a set U={e₁,L,eₙ}, each element eᵢ in U is converted into a random point vᵢ in one dimensional space. The collision-resistant Hash function hash is used to realize this conversation, that is,

(v₁,L,vₙ)=(hash(e₁),L,hash(eₙ))∈¢ⁿₚ (2)

Where, ¢ⁿₚ denotes the n integers under module p and each element eᵢ is represented by the arbitrary length binary string. We do not limit the size of U because the number of elements is usually far less than the size of ¢ⁿₚ (e.g., p>2²⁵⁶ for a secure elliptic curve).

2) Function-Generating Phase

Given a subset S={e′₁,L,e′ₘ}⊂U, a zeros-based polynomial ƒ_{S}(x) could be derived from all random points (v′₁,L,v′ₙ)=(hash(e′¹),L,hash(e′ₙ)) which are considered as the (negative) zeros of polynomial. Exactly, the polynomial ƒ_{S}(x) is defined as:

$${f}_{S} ( x ) = x ( x + {v}_{1}^{′} ) … ( x + {v}_{m}^{′} ) = x \cdot {\prod }_{{e}_{i}^{′} ∈ S} ( x + {v}_{i}^{′} ) mod p . \qquad ( 3 )$$

3) Secret-Determining Phase

A random secret γ is introduced to generate ƒ_{S}(γ) by using the polynomial ƒ_{S}(x), that is,

ƒ_{S}(γ)=γΣ_{e′}_{ᵢ}_{∈S}(γ+v′ᵢ)mod p. (4)

And then produces the public parameter mpk=(g₁,g₂,L,gₘ)=(g^{γ},g^{γ2},L,g^{γ}^{^{m}}) from γ.

4) Cipher-Processing Phase

In this phase, the zeros-based representation of set S is generated by using the function ƒ_{S}(γ) and the public parameter mpk. Firstly, the zeros-based representation of set S is defined as

$${g}^{{f}_{S} ( γ )} = {g}^{γ {\prod }_{{e}_{i}^{′} ∈ S} ( γ + {v}_{i}^{′} )} ∈ G , \qquad ( 5 )$$

where, g is the generator of group G.

Next ƒ_{S}(x)=xΠ_{e′}_{ᵢ}_{∈S}(x+v′ᵢ)=Σₖ₌₀^{m}aₖx^{k+1}, where the coefficient aₖ can be computed only if all elements in S are known. According to Equation (5), the zeros-based aggregation value is also able to computed by using the public parameter mpk={gᵢ=g^{γ}^{ⁱ}}_{i∈[1,m]} as follows:

G_{S}=gΣₖ₌₀^{m}aₖγ^{(k+1)}=Πₖ₌₁^{m+1}gₖ^{a}^{_{k−1}}. (6)

Note that, when S=Ø, the output of this function is ZerosAggr(mpk,Ø)=g₁=g^{γ}.

In this embodiment, a function is called the Zeros-based Aggregation (in short, ZerosAggr) function since the hash values of all elements in S are used for the (negative) zeros in the polynomial ƒ_{S}(x). The Zeros-based Aggregation is defined as follows:

Given a subset S={e₁,L,eₙ}⊂U and a cyclic group G, an algorithm is called Zeros-based Aggregation function if there exists a polynomial-time algorithm that outputs

$${G}_{S} = ZerosAggr ( mpk , S ) = {g}^{γ \cdot {\prod }_{{e}_{i}^{′} ∈ S} ( γ + {v}_{i} )} ,$$

where, mpk={gᵢ=g^{γ}^{ⁱ}}_{i∈[1,|U|]} is the public parameter, g is a generator in G, vᵢ=hash(eᵢ) and γ is a secret.

(3) Construction of Poles-Based Aggregation Function

Secondly, the poses-based aggregation function PolesAggr is constructed according to four following phases:

1) Randomizing Phase

Let G be the same cyclic group of prime order p in ZerosAggr and h is a generator of G. Given a set U={e₁,L,eₙ}, the collision-resistant Hash function hash is used to realize the mapping from elements to random points, that is,

(v₁,L,vₙ)=(hash(e₁),L,hash(eₙ))∈¢ⁿₚ. (7)

2) Function-Generating Phase

Given a subset S={e′₁,L,e′ₘ}⊂U, a poles-based polynomial g_{S}(x) could be derived from all points (v′₁,L,v′ₙ)=(hash(e′₁),L,hash(e′ₙ)) which are considered as the (negative) poles of polynomial. Exactly, the polynomial g_{S}(x) is defined as:

$${g}_{S} ( x ) = \frac{1}{( x + {v}_{i}^{′} ) … ( x + {v}_{m}^{′} )} = \frac{1}{{\prod }_{{e}_{i}^{′} ∈ S} ( x + {v}_{i}^{′} )} mod p . \qquad ( 8 )$$

3) Secret-Determining Phase

A random secret γ is introduced to generate g_{S}(γ), that is,

g_{S}(γ)=Π_{e′}_{ᵢ}_{∈S}(γ+v′ᵢ)⁻¹ mod p. (9)

And then produces the public parameter mpk=(h₁,h₂,L,hₘ)=(h^{1/γ+v′}^{₁},h^{1/γ+v′}^{₂},L,h^{1/γ+v′}^{ₘ}) from γ.

4) Cipher-Processing Phase

The poles-based representation of set S is defined as

$${H}_{S} = {h}^{{g}_{S} ( γ )} = {h}^{\frac{1}{{\prod }_{{e}_{i}^{′} ∈ S} ( x + {v}_{i}^{′} )}} ∈ G , \qquad ( 10 )$$

where, h is the generator of cyclic group G.

We provide a fast recursive method to realize the PolesAggr function from the public parameter

$$mpk = {\{ {h}_{i} = {h}^{\frac{1}{y + {v}_{i}}} \}}_{{e}_{i} ∈ U} .$$

Firstly, let us see the aggregation between two elements: given hᵢ and hⱼ, it is easy to obtain the equation

$${( {h}_{j} / {h}_{i} )}^{\frac{1}{{v}_{i}^{′} - {v}_{j}^{′}}} = {( {h}^{\frac{1}{γ + {v}_{j}^{′}} /} {h}^{\frac{1}{γ + {v}_{i}^{′}}} )}^{\frac{1}{{v}_{i}^{′} - {v}_{j}^{′}}} = {h}^{\frac{1}{( γ + {v}_{i}^{′} ) ( γ + {v}_{j}^{′} )}} , \qquad ( 11 )$$

where vᵢ≠vⱼ is a precondition for this equation for avoiding error with dividing by zero. Next, we expand this equation to multi-value cases. Set

$${B}_{i , j} = {h}^{\frac{1}{{\prod }_{k = i}^{j} ( γ + {v}_{k}^{′} )}} = {h}^{\frac{1}{γ + {v}_{i}^{′}} L \frac{1}{γ + {v}_{j}^{′}}} ,$$

The poles-based aggregation value

$${H}_{S} = {B}_{1 , m} = {h}^{\frac{1}{{\prod }_{{e}_{i}^{′} ∈ S}^{ } ( x + {v}_{i}^{′} )}}$$

can be computed by

$$\{ \begin{matrix}{B}_{i , i} = {h}_{i} & ∀ i ∈ [ 1 , m ] \\ {B}_{i , j} = {( {B}_{i , j} / {B}_{i + 1 , j + 1} )}^{\frac{1}{{v}_{j + 1}^{′} - {v}_{i}^{′}}} & i ∈ [ 1 , m - 1 ] , j ∈ [ 2 , m ]\end{matrix} \qquad ( 12 )$$

In this embodiment, a function is called the Poles-based Aggregation (in short, PolesAggr) function since the hash values of all elements in S are used for the (negative) poles in the polynomial g_{S}(x). The Poles-based Aggregation is defined as follows:

Given a subset S={e₁,L,eₘ}⊂U and a cyclic group G, an algorithm is called Poles-based Aggregation function if there exists a polynomial-time algorithm that outputs

$${H}_{S} = PolesAggr ( mpk , S ) = {h}^{\frac{1}{{\prod }_{{e}_{i}^{′} ∈ S} ( γ + {v}_{i} )}} ,$$

where,

$$mpk = {\{ {h}_{i} = {h}^{\frac{1}{y + {v}_{i}}} \}}_{{e}_{i} ∈ U}$$

is the public parameter, h is a generator in G, vᵢ=hash(eᵢ) and γ is a secret.

In this embodiment, the information of the set S is compressed and represented as a random number (or vector) in a cryptographic space by zeros-based aggregation function or poles-based aggregation function. Next, the aggregated value can decided the memberships in a cryptographic approach, such as: ‘equal’ and ‘unequal’ between two elements, ‘inclusion’ and ‘exclusion’ between two sets, and ‘positive’ and ‘negative’ membership whether one element is in a set of elements.

(4) Security of Zeros-Based Aggregation Function

The accuracy and reliability of decision-making of ‘positive’ membership depends on the security of the zeros-based aggregation function. In this embodiment, the security of zeros-based aggregation function satisfies the following requirements:

Given an element eᵢ∈U and a subset S⊂U, let S₋=S\{eᵢ} and

$${G}_{S -} = {G}_{S \backslash \{ {e}_{i} \}} = {g}^{\frac{{f}_{S} ( γ )}{γ + {v}_{i}}} = {g}^{\frac{γ {\prod }_{{e}_{i}^{′} ∈ S} ( γ + {v}_{i}^{′} )}{γ + {v}_{i}}} . \qquad ( 13 )$$

A function on S is called the secure zeros-based aggregation if it has the following two properties:
Easy to compute G_{S-} for eᵢ∈S, that is, the value G_{S}_{_{−}} can be computed by

$$ZerosAggr ( mpk , {S}_{-} ) = {g}^{γ {\prod }_{{e}_{i}^{′} ∈ S , {e}_{i}^{′} \neq {e}_{i}} ( γ + {v}_{i}^{′} )}$$

within a polynomial-time;
Hard to compute G_{S-} for eᵢ∉S, that is, any PPT algorithm (including ZerosAggr(mpk,S₋)) computing G_{S}_{_{−}} succeeds with negligible probability.

These two properties can ensure the security of decision-making of positive membership.

(5) Security of Poles-Based Aggregation Function

The accuracy and reliability of decision-making of ‘negative’ membership depends on the security of the poles-based aggregation function. In this embodiment, the security of poles-based aggregation function satisfies the following requirements:

Given an element eᵢ∈U and a subset S⊂U, let S₊=S\{eᵢ} and

$${H}_{S +} = {H}_{S ⋃ \{ {e}_{i} \}} = {h}^{{g}_{S} ( γ ) \cdot \frac{1}{γ + {v}_{i}}} = {h}^{\frac{1}{{\prod }_{{e}_{i}^{′} ∈ S}^{ } ( x + {v}_{i}^{′} )} \cdot \frac{1}{{ }^{( γ + {v}_{i} )}}} \qquad ( 14 )$$

A function on S is called the secure poles-based aggregation if it has the following two properties:
Easy to compute H_{S+} for eᵢ∉S, that is, the value H_{S+} can be computed by

$$PolesAggr ( mpk , {S}_{+} ) = {h}^{\frac{1}{{\prod }_{{e}_{i}^{′} ∈ S}^{ } ( x + {v}_{i}^{′} )} \cdot \frac{1}{{ }^{( γ + {v}_{i} )}}}$$

within a polynomial-time;
Hard to compute H_{S+} for eᵢ∈S, that is, any PPT algorithm (including PolesAggr(mpk,S₊)) computing H_{S+} succeeds with negligible probability.

These two properties can ensure the security of decision-making of negative membership.

(6) Cryptographic Decision-Making of Positive Membership

In order to achieve the decision-making of positive membership, this invention introduces the concept of commitment. Commitment, which contains two processes: commitment-generating and commitment-verifying, is a basic concept in cryptography. No one can guess the secret in the commitment after the commitment is built, but we can verify the consistency between the commitment and its hidden secret if we obtain some specific values (called clues).

In this embodiment, the cryptographic decision-making of positive and negative membership is built on the general bilinear pairing system that can be indicated as S={p,G,G_{T},e(•,•)}. In this system, G and G_{T} are two multiplicative cyclic groups of prime order p, and elements g and h are the generators of G_{T} and then the bilinear pairing can be indicated as e: G×G a G_{T}. This system should have the following properties:

1) Bilinear: For any a,b belong to ¢*ₚ, it can get e(g^{a},h^{b})=e(g,h)^{ab};

2) Non-degenerate: e(g,h)≠1;

3) Computable: There is a polynomial-time algorithm to calculate e(g,h).

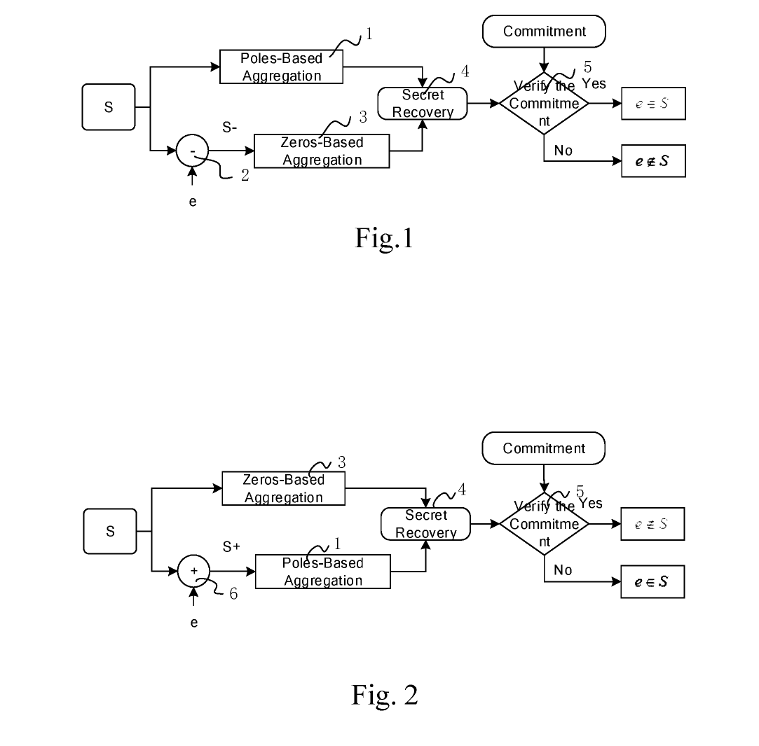

FIG. 1 is a flow diagram that implementing cryptographic decision-making of positive membership, described as follows:

For any given set S, the poles-based aggregate function 1 PolesAggr(mpk,S) is invoked to calculate the aggregation value H_{S} of set S. And then, a random secret k is introduced to construct the value H_{S}'s commitment

$${H}_{S} = {h}^{{g}_{s} ( γ ) k} = {h}^{\frac{k}{{ }^{{\prod }_{{r}_{i} ∈ S}^{ } ( γ + {v}_{i} )}}} and {g}^{γ k} .$$

For a given element e satisfying e∉S, let S₋=S\{e} 2 according to the security definition of zeros-based aggregation function.

The zeros-based aggregation function 3 ZerosAggr(mpk,S₋) is invoked to calculate the aggregation value

$${G}_{s -} = ZerosAggr ( mpk , {S}_{-} ) = {G}_{S \backslash \{ e \}} = {g}^{{f}_{S -} ( γ )} = {g}^{\frac{{f}_{S} ( γ )}{γ + v}} = {g}^{\frac{γ {\prod }_{{e}_{i} ∈ S} ( γ + {v}_{i} )}{γ + v}} . \qquad ( 15 )$$

Where, v=hash(e) and vᵢ=hash(eᵢ).

The following secret value is recovered 4 from

$$e ( {G}_{S -} , {H}_{S} ) = e ( {g}^{{{f}_{S}}_{-} ( γ )} , {h}^{{g}_{S} ( γ ) k} ) = e ( {g}^{\frac{γ {\prod }_{{e}_{i} ∈ S} ( γ + {v}_{i} )}{γ + v}} , {h}^{\frac{k}{{\prod }_{{e}_{i} ∈ S} ( γ + {v}_{i} ) }} ) = {e ( g , h )}^{\frac{γ \cdot k}{γ + v}} . \qquad ( 16 )$$

The above commitment is verified 5 by using

$${e ( g , h )}^{\frac{γ k}{γ + v}} = e ( {g}^{γ k} , {h}^{\frac{1}{γ + v}} ) ,$$

where is

$${h}^{\frac{1}{γ + v}}$$

directly derived from mpk.

Conversely, if e∉S, according to the security definition of zeros-based aggregation function, it is computably difficult to recover the particular value

$${e ( g , h )}^{\frac{γ \cdot k}{γ + v}} ,$$

therefore the commitment verification 5 cannot be passed.

In summary, the above-mentioned method makes more efficient and precise for decision-making of positive membership. That is, it not only improves the efficiency of decision-making process, but also ensures the security and consistency of decision-making.

(7) Cryptographic Decision-Making of Negative Membership

FIG. 2 is a flow diagram that implementing cryptographic decision-making of negative membership, described as follows:

For any given set S, the zeros-based aggregate function 3 ZerosAggr(mpk,S) is invoked to calculate the aggregation value G_{S} of set S. And then, a random secret k is introduced to construct the value G_{S}'s commitment

$${G}_{s} = {g}^{{f}_{s} ( γ ) k} = {g}^{k {γΠ}_{{e}_{i} ∈ S} ( γ + {v}_{i} )}$$

and g^{γk}.

For a given element e satisfying e∉S, let S₊=S∪{e} 6 according to the security definition of poles-based aggregation function.

The poles-based aggregation function 1 PolesAggr(mpk,S+) is invoked to calculate the aggregation value

$${H}_{{S}_{+}} = PolesAggr ( mpk , {S}_{+} ) = {H}_{S ⋃ \{ e \}} = {h}^{{g}_{{S}_{+} ( γ )}} = {h}^{{g}_{S} ( γ ) \cdot \frac{1}{γ + v}} = {h}^{\frac{1}{{\prod }_{k = s}^{r} ( γ + {v}_{k} )} \cdot \frac{1}{{ }^{( γ + v )}}} \qquad ( 17 )$$

Where, v=hash(e) and vᵢ=hash(eᵢ).

The following secret value is recovered 4 from

$$e ( {G}_{s} , {H}_{S +} ) = e ( {g}^{{f}_{S} ( γ ) k} , {h}^{{g}_{S +} ( γ )} ) = e ( {g}^{k γ {\prod }_{q ∈ S} ( γ + {v}_{i} )} , {h}^{\frac{1}{{\prod }_{{e}_{i} ∈ s}^{ } ( γ + {v}_{i} )} \cdot \frac{1}{{ }^{( γ + v )}}} ) = {e ( g , h )}^{\frac{γ \cdot k}{γ + v}} \qquad ( 18 )$$

The above value is verified 5 by using

$${e ( g , h )}^{\frac{γ k}{γ + v}} = e ( {g}^{γ k} , {h}^{\frac{1}{{ }^{γ + v}}} ) ,$$

where

$${h}^{\frac{1}{{ }^{γ + v}}}$$

is directly derived from mpk.

Conversely, if e∈S, according to the security definition of poles-based aggregation function, it is computably difficult to recover the particular value

$${e ( g , h )}^{\frac{γ \cdot k}{γ + v}} ,$$

therefore the verification 5 cannot be passed.

In summary, the above-mentioned method makes more efficient and precise for decision-making of negative membership. That is, it not only improves the efficiency of decision-making process, but also ensures the security and consistency of decision-making.

In this embodiment of the invention, for instance, it can take some similar cryptographic implementation to verify other relationships, such as the equation relationship between two sets, the inclusion relationship between a set and another set, or the disjoint relationship (also known as not totally inclusion) of two sets.

Another embodiment of the invention is described as follows:

The invention also provides a specific embodiment of cryptographic system of secure decision-making of membership. Considering that the corresponding relation between the construction of this system and the above-mentioned embodiment of decision-making method of membership, the embodiment of cryptographic system can execute the above-mentioned decision-making method of membership to achieve the purpose of the invention. Therefore, the explanation of implementation of cryptographic method of decision-making of membership also applied to the implementation of cryptographic system of decision-making of membership. We do not repeat to explain in the following specific embodiment of the invention.

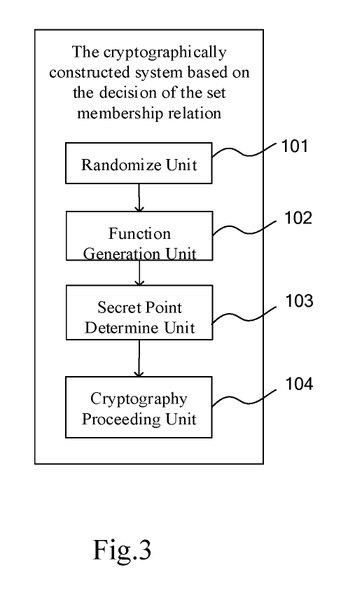

FIG. 3 is a structural diagram of cryptographic system of decision of membership on set, which includes:
Randomizing Unit 101, which is configured to acquire any given set U={e₁, . . . , eₙ} and transform each element eᵢ in the set U into a random point vᵢ in a cryptographic space;
Function-Generating Unit 102, which is configured to acquire a given set S={e′₁, . . . , e′ₘ}⊂U, determine a random point v′ᵢ corresponding to each element e′ᵢ in the set S according to the random point vᵢ, and construct a function ƒ_{S}(x) according to the random point v′ᵢ;
Secret-determining Unit 103, which is configured to introduce a random secret γ, determine a function ƒ_{S}(γ) according to the function ƒ_{S}(x), and determine a public parameter mpk according to the random secret γ; and
Cipher-Processing Unit 104, which is configured to process the function ƒ_{S}(γ) by using the public parameter mpk as an input to generate a cryptographic representation of the set S via a cryptographic method.

During the procedure described above, all elements in a given set might be represented as a random number or a random vector in the cryptographic space, which can be used in cryptographic decision-making of membership between the set and the set, the set and the element, or the element and the element.

In this embodiment, optionally, the cipher-processing unit comprising:

Processing module, which is configured to process the function ƒ_{S}(γ) by using the public parameter mpk as an input to generate an aggregation function Aggregate(mpk,S) of the set S via cryptographic method, wherein the aggregation function is called a zeros-based aggregation function ZerosAggr(mpk,S) if the function ƒ_{S}(x) is a zeros-based polynomial, or the aggregation function is called a poles-based aggregation function PolesAggr(mpk,S) if the function ƒ_{S}(x) is a poles-based polynomial; and

Compressing module, which is configured to compress the set S into a constant-size random number or random vector R_{S} by means of the aggregation function, wherein R_{S} is an aggregated value outputted by the aggregation function Aggregate(mpk,S), and the size of R_{S} is independent of the number of elements in the set S.

According to one or more embodiments of the present invention, the constant-size random number or random vector R_{S} is used to generate the cryptographic decision-making device, includes:

The First Decision-Making Unit, which is configured to construct a cryptographic determination algorithm by means of the aggregation function for determining equality and inequality relationships between elements; and/or

The Second Decision-Making Unit, which is configured to construct a cryptographic determination algorithm by means of the aggregation function for determining positive and negative affiliation memberships between elements and the set; and/or

The Third Decision-Making Unit, which is configured to construct a cryptographic determination algorithm by means of the aggregation function for determining positive and negative containment relationships between the sets.

In the foregoing specification, optionally, the embodiments of the invention can construct the second decision device that realizes the cryptographic system of decision-making of membership. The following processes may perform the decision-making of membership:

the second determination unit is further configured to acquire an element eᵢ, and when eᵢ∈S, set S=S\{eᵢ}, then determine the aggregated value R_{S}_{_{−}} by the zeros-based aggregation function ZerosAggr(mpk,S₋); and when eᵢ∉S, set S₋=S\{eᵢ}, then determine the aggregated value R_{S}_{_{−}} by none of polynomial-time algorithms, the polynomial-time algorithms comprise ZerosAggr(mpk,S₋); and

the second determination unit is further configured to acquire an element eᵢ, when eᵢ∉S, set S₊=S∪{eᵢ}, then determine the aggregated value R_{S}_{₊} by the pole-based aggregation function PolesAggr(mpk,S₊); and when eᵢ∈S, set S₊=S∪{eᵢ}, then determine the aggregated value R_{S}_{₊} by none of polynomial-time algorithms, the polynomial-time algorithms comprise PolesAggr(mpk,S₊).

The preferred embodiment of the present invention is described above. It should be pointed out that the general technical individual of technical field can also make some improvement and polishing, without departing from the principles of the present invention, which should be regarded as the scope of protection.

What is claimed is:

1. A cryptographic construction method for determining a set membership, comprising:
acquiring any given set U={e₁, . . . , eₙ}, and transforming each element eᵢ in the set U into a random point vᵢ in a cryptographic space;
acquiring a given set S={e′₁, . . . , e′ₘ}⊂U, determining a random point v′ᵢ corresponding to each element e′ᵢ in the set S according to the random point vᵢ, and constructing a function ƒ_{S}(x) according to the random point v′ᵢ;
introducing a random secret γ, determining a function ƒ_{S}(γ) according to the function ƒ_{S}(x), and determining a public parameter mpk according to the random secret γ; and
processing the function ƒ_{S}(γ) by using the public parameter mpk as an input to generate a cryptographic representation of the set S via a cryptographic method.

2. The cryptographic construction method according to claim 1, wherein the random point comprises a random number or a random vector; constructing a function ƒ_{S}(x) according to the random point v′ᵢ comprises:
constructing a zeros-based polynomial ƒ_{S}(x) by setting the random point v′ᵢ corresponding to each element e′ᵢ in the set S as a zero of the polynomial H(x); or
constructing a poles-based polynomial ƒ_{S}(x) by setting the random point v′ᵢ corresponding to each element e′ᵢ in the set S as a pole of the polynomial H(x);
wherein H(x) is a rational polynomial with a form H(x)=P(x)/Q(x), which is the quotient of two polynomial P(x) and Q(x); for a variable z, the root z of P(x) is called a zero of H(x) if P(z)=0, and the root z of Q(x) is called a pole of H(x) if Q(z)=0;
the constructed function also comprises a Lagrange interpolation polynomial, Newton interpolation polynomials, Hermite interpolation polynomials, Bernstein polynomials and Fibonacci polynomials, Binomial polynomials or corresponding algebraic curves constructed from the random point v′ᵢ.

3. The cryptographic construction method according to claim 1, wherein the processing the function ƒ_{S}(γ) by using the public parameter mpk as an input to generate a cryptographic representation of the set S via a cryptographic method comprises:
processing the function ƒ_{S}(γ) by using the public parameter mpk as an input to generate an aggregation function Aggregate(mpk,S) of the set S via cryptographic method, wherein the aggregation function is called a zeros-based aggregation function ZerosAggr(mpk,S) if the function ƒ_{S}(x) is a zeros-based polynomial, or the aggregation function is called a poles-based aggregation function PolesAggr(mpk,S) if the function ƒ_{S}(x) is a poles-based polynomial; and
compressing the set S into a constant-size random number or random vector R_{S} by means of the aggregation function, wherein R_{S} is an aggregated value outputted by the aggregation function Aggregate(mpk,S), and the size of R_{S} is independent of the number of elements in the set S.

4. The cryptographic construction method according to claim 3, after the compressing the set S into a constant-size random number R_{S} by means of the aggregation function, further comprising:
constructing a cryptographic determination algorithm by means of the aggregation function for determining equality and inequality relationships between elements; and/or
constructing a cryptographic determination method by means of the aggregation function for determining positive and negative affiliation memberships between elements and the set; and/or
constructing a cryptographic determination method by means of the aggregation function for determining positive and negative containment relationships between the sets.

5. The cryptographic construction method according to claim 4, wherein the constructing a cryptographic determination algorithm by means of the aggregation function for determining a positive affiliation membership between elements and the set comprises:
acquiring an element eᵢ, and when eᵢ∈S, setting S₋=S\{eᵢ}, then determining the aggregated value R_{S}_{_{−}} by the zeros-based aggregation function ZerosAggr(mpk,S₋); and
when eᵢ ∉S, setting S₋=S\{eᵢ}, then determining the aggregated value R_{S}_{_{−}} by none of polynomial-time algorithms, the polynomial-time algorithms comprise ZerosAggr(mpk,S₋);
the constructing a cryptographic determination algorithm by means of the aggregation function for determining a negative affiliation membership between elements and the set comprises:
acquiring an element eᵢ, when eᵢ ∉S, setting S₊=S∪{eᵢ}, then determining the aggregated value R_{S}_{₊} by the pole-based aggregation function PoiesAggr(mpk,S₊); and
when eᵢ∈S, setting S₊=S∪{eᵢ}, then determining the aggregated value R_{S}_{₊} by none of polynomial-time algorithms, the polynomial-time algorithms comprise PolesAggr(mpk,S₊).

6. The cryptographic construction method according to claim 5, wherein the constructing a cryptographic determination algorithm by means of the aggregation function for determining a positive affiliation membership between elements and the set comprises:
constructing a commitment on the aggregated value R_{S} according to the outputted aggregated value R_{S} of the set S from the poles-based aggregation function PolesAggr(mpk,S);
for the element eᵢ, when eᵢ ∈S, verifying the commitment according to the determined aggregated value R_{S}_{_{−}} outputted by the zeros-based aggregation function ZerosAggr(mpk,S₋); and
when eᵢ∉S, verifying the commitment by none of polynomial-time algorithms;
the constructing a cryptographic determination algorithm by means of the aggregation function for determining a negative affiliation membership between elements and the set comprises:
constructing a commitment on the aggregated value R_{S} according to the outputted aggregated value R_{S} of the set S from the zeros-based aggregation function ZerosAggr(mpk,S);
for the element eᵢ, when eᵢ ∉S, verifying the commitment according to the determined aggregated value R_{S}_{_{−}} outputted by the poles-based aggregation function PolesAggr(mpk,S₊); and
when eᵢ∉S, verifying the commitment by none of polynomial-time algorithms.

7. A cryptographic construction system for determining a set membership, comprising:
a randomizing unit, which is configured to acquire any given set U={e₁, . . . , eₙ} and transform each element eᵢ in the set U into a random point vᵢ in a cryptographic space;
a function generating unit, which is configured to acquire a given set S={e′₁, . . . , e′ₘ}⊂U, determine a random point v′ᵢ corresponding to each element e′ᵢ in the set S according to the random point vᵢ, and construct a function ƒ_{S}(x) according to the random point v′ᵢ;
a secret point determining unit, which is configured to introduce a random secret γ, determine a function ƒ_{S}(γ) according to the function ƒ_{S}(x), and determine a public parameter mpk according to the random secret γ; and
a cryptographic processing unit, which is configured to process the function ƒ_{S}(γ) by using the public parameter mpk as an input to generate a cryptographic representation of the set S via a cryptographic method.

8. The cryptographic construction system according to claim 7, wherein the cryptographic processing unit comprises:
a processing module, which is configured to process the function ƒ_{S}(γ) by using the public parameter mpk as an input to generate an aggregation function Aggregate(mpk,S) of the set S via cryptographic method, wherein the aggregation function is called a zeros-based aggregation function ZerosAggr(mpk,S) if the function ƒ_{S}(x) is a zeros-based polynomial, or the aggregation function is called a poles-based aggregation function PolesAggr(mpk,S) if the function ƒ_{S}(x) is a poles-based polynomial; and
a compressing module, which is configured to compress the set S into a constant-size random number or random vector R_{S} by means of the aggregation function, wherein R_{S} is an aggregated value outputted by the aggregation function Aggregate(mpk,S), and the size of R_{S} is independent of the number of elements in the set S.

9. The cryptographic construction system according to claim 8, further comprising:
a first determination unit, which is configured to construct a cryptographic determination algorithm by means of the aggregation function for determining equality and inequality relationships between elements; and/or
a second determination unit, which is configured to construct a cryptographic determination algorithm by means of the aggregation function for determining positive and negative affiliation memberships between elements and the set; and/or
a third determination unit, which is configured to construct a cryptographic determination algorithm by means of the aggregation function for determining positive and negative containment relationships between the sets.

10. The cryptographic construction system according to claim 9, wherein the second determination unit is further configured to acquire an element eᵢ, and when eᵢ ∈S, set S₋=S\{eᵢ}, then determine the aggregated value R_{S}_{_{−}} by the zeros-based aggregation function ZerosAggr(mpk,S₋); and when eᵢ ∉S, set S₋=S\{eᵢ}, then determine the aggregated value R_{S}_{_{−}} by none of polynomial-time algorithms, the polynomial-time algorithms comprise ZerosAggr(mpk,S₋); and
the second determination unit is further configured to acquire an element eᵢ, when eᵢ ∉S, set S₊=S∪{eᵢ}, then determine the aggregated value R_{S}_{₊} by the pole-based aggregation function PoiesAggr(mpk,S₊); and when eᵢ∈S, set S₊=S∪{eᵢ}, then determine the aggregated value R_{S}_{₊} by none of polynomial-time algorithms, the polynomial-time algorithms comprise PoiesAggr(mpk,S₊).
